(19) United States
(12) Patent Application Publication
(10) Pub. No.: US 2007/0219828 A1
(43) Pub. Date: Sep. 20, 2007

(54) System and method for providing information with respect to the use of healthcare spending accounts

(75) Inventors: James Coe Schlicher, Albuquerque, NM (US); David Jason Goldman, Decatur, GA (US)

Correspondence Address: GREENBERG TRAURIG, LLP, 77 WEST WACKER DRIVE, SUITE 2500, CHICAGO, IL, 60601-1732, US

(73) Assignee: SimpleHx, LLC, Chicago, IL (US)

(21) Appl. No.: 11/712,818

(22) Filed: Mar. 1, 2007

Related U.S. Application Data
(60) Provisional application No. 60/783,049, filed on Mar. 16, 2006.

(51) Int. Cl. G06Q 10/00; G06Q 40/00

(52) U.S. Cl. 705/2; 705/35; 705/4

(57) ABSTRACT

A system and method which considers information such as amounts in one or more healthcare accounts of a consumer, limitations of a healthcare plan under which the consumer is covered, relevant tax rates for the consumer, rate(s) of return on investment for out-of-pocket fund(s) of the consumer, and rate(s) of return on investment for healthcare spending account(s) of the consumer to evaluate and inform the consumer how the consumer should spend the amounts in their healthcare accounts and/or out-of-pockets accounts to meet to-be-paid costs associated with a healthcare bill.

### BACKGROUND

Systems and methods for managing aspects of healthcare accounts are known. In this regard, as described in published U.S. Patent Application No. 2004/0073465, healthcare accounts may include flexible spending accounts (“FSAs”) and/or health reimbursement arrangements (“HRAs”). FSAs are generally healthcare accounts which are funded by pre-tax payroll deductions and setup by an employee as a means for paying for healthcare expenses not otherwise covered by the insurance carrier of the employee. A notable drawback of FSAs is that any unused portion of the funds in the account may not be rolled over to the next plan year for use by the employee. Meanwhile, HRAs are generally healthcare accounts which receive contributions from the employer for the benefit of the employee. While monetary contributions to an HRA may be rolled over from one plan year to the succeeding plan year, if the employee terminates employment with the employer, the employer will keep the unused portions of the monetary contributions within the HRA.

A still further healthcare account is a health savings account (“HSA”). An HSA is generally a savings product established by the employee with a financial institution into which the employee may deposit money on a tax-preferred basis. The HSA enables an employee to pay for current uncovered healthcare expenses and/or save for future qualified medical and retiree healthcare expenses. The employee owns and controls the money in the HSA and, as such, decisions on how to spend the money within the HSA may be made by the employee without relying on a third party or a health insurer. Furthermore, the employee will also be able to decide what types of investments to make with the money in the HSA account in order to make it grow.

For assisting a user in determining how to fund these various healthcare accounts various systems and methods are also known. For example, published U.S. Patent Application No. 2002/0147617 describes a healthcare cost calculator that is provided to allow an employee to determine how much money the employee might want to allocate to a FSA. To this end, the described system and method presents to a user information on the distribution of out-of-pocket costs for healthcare that the user is likely to incur in the coming year based on factors such as the limits of their healthcare plan, known family health issues, and actual healthcare use and costs for a reference population comparable to the user. From this information, the employee may make an optimal contribution to their FSA for the upcoming year. Similarly, published U.S. Patent Application No. 2002/0087444 describes a system and method for allowing an employer to manage contributions to an employer-funded heath care account.

To allow an employee to monitor healthcare benefits and to view their individual personal healthcare histories, published U.S. Patent Application No. 2005/0010446 describes a system and method that functions to log and track specific medical events and payment information associated with the medical events. In this manner, the described software product allows the employee to reconcile healthcare costs and payments associated with the medical events. Further, the system and method described in published U.S. Patent Application No. 2005/0010446 provides limited planning tools such as, for example, a planning tool to assist the employee in making decisions as to when to make discretionary purchases of healthcare related goods and/or services.

For automatically settling claims using the various healthcare accounts, published U.S. Patent Application No. 2006/0020495 describes a claim processing mechanism which receives from a participating member, e.g., healthcare provider or employee participant, a claim submission specifying healthcare services and expenses provided to the employee. The claim submission will also include a request for payment or reimbursement of the same. The claim processing mechanism then functions to process the claim by validating the claim information and, if validated, by instructing a financial institution holding a funded account to pay the amount specified in the claim.

While such known systems and methods generally work for their intended purpose, what is still needed in the art is a system and method for helping participants in making current as well as future healthcare payment decisions with a goal towards maximizing their healthcare dollars while allowing the participants to plan and save for future healthcare costs.

### SUMMARY OF THE INVENTION

To address this and other needs, the subject invention is generally directed to a system and method for providing information with respect to the use of healthcare spending accounts.

A better understanding of the objects, advantages, features, properties and relationships of the invention will be obtained from the following detailed description and accompanying drawings which set forth illustrative embodiments and which are indicative of the various ways in which the principles of the invention may be employed.

### BRIEF DESCRIPTION OF THE DRAWINGS

For a better understanding of the various aspects of the invention, reference may be had to preferred embodiments shown in the attached drawings in which:

FIG. 1 illustrates in flow chart form an exemplary method for providing information with respect to the use of healthcare spending accounts;

FIG. 2 illustrates in flow chart form an exemplary method for determining availability of use of a HRA spending account in keeping with the exemplary method illustrated in FIG. 1;

FIG. 3 illustrates in flow chart form an exemplary method for determining availability of use of a FSA spending account in keeping with the exemplary method illustrated in FIG. 1;

FIG. 4 illustrates in flow chart form an exemplary method for determining availability of use of a HSA spending account in keeping with the exemplary method illustrated in FIG. 1;

FIG. 5 illustrates in flow chart form an exemplary method for determining efficiency of use of a HSA spending account in keeping with the exemplary method illustrated in FIG. 1;

FIG. 6 illustrates in block diagram form an exemplary system in which the exemplary method illustrated in FIG. 1 may be used;

FIG. 7 illustrates in block diagram form a further exemplary system in which the exemplary method illustrated in FIG. 1 may be used;

FIG. 8 illustrates in block diagram form a yet further exemplary system in which the exemplary method illustrated in FIG. 1 may be used;

FIG. 9 illustrates a screen shot of an exemplary home page presentable to a user of the system;

FIG. 10 illustrates a screen shot of an exemplary account activity page presentable to a user of the system;

FIG. 11 illustrates a screen shot of an exemplary coverage summary page presentable to a user of the system;

FIG. 12 illustrates a screen shot of an exemplary information page presentable to a user of the system;

FIGS. 13-17 illustrate screen shots of an exemplary account usage analysis page presentable to a user of the system; and

FIG. 18 illustrates a screen shot of an exemplary incentives usage analysis page presentable to a user of the system.

### DETAILED DESCRIPTION

Turning now to the figures, wherein like reference numerals refer to like elements, an exemplary system and method for providing information with respect to the use of healthcare spending accounts is herein described. In this context, it is to be appreciated that Consumer Driven Health Plans (CDHPs) are growing rapidly and, as a result, members are being asked to shoulder a greater responsibility for how their healthcare needs are financed. Yet, despite the commitment to educate members in becoming better healthcare consumers, members are often confused and looking for guidance on how to best fund their current healthcare costs as well as how to save for their future healthcare needs. To address these concerns, the illustrated and described system will not only provide the tools necessary to navigate spending accounts, i.e., those healthcare spending accounts that presently exist as well as those which may be made available in the future, but will also serve to help members make healthcare spending decisions for the purpose of maximizing their healthcare dollars as concerns present and future healthcare costs.

It will be further appreciated from the description which follows that the subject system and method will provide benefits not only to healthcare consumers but also to various other entities such as, for example, insurance carriers, debit card vendors, and/or healthcare providers.

As concerns healthcare consumers, the subject system will provide to healthcare consumers resources that allow healthcare consumers to describe and manage the key features of their healthcare spending accounts, a single site solution to view account balances and activity information, the ability to track spending account dollars and funds especially those spent directly from their own pocket, the ability to download summary reports of healthcare expenses (for example to be used in connection with tax preparation), strategies to maximize their healthcare dollars according to individualized needs, guidance on decisions to use or save spending account dollars, real-time comparisons of the long-term effects of using or saving spending account dollars, the opportunity to see the value of how healthcare choices effect long-term savings (e.g., the value of generic drugs versus brand drugs), financial analysis of the value of available incentives, increased awareness of updates and the impacts of healthcare legislative policy changes, etc.

As concerns insurance carriers, the subject system and method will provide a means for insurance carriers to engage and empower their members to make financially sound decisions (i.e., the subject system allows members of insurance carriers to view their spending account balances and activities which will thereby allow the members to track their healthcare spending while helping insurance carriers meet their goal of creating better healthcare consumers) and thus further advance insurance carriers efforts in creating more responsible healthcare consumers and ultimately impact healthcare utilization, create a competitive advantage for the insurance carrier in the CDHP marketplace (e.g., by allowing the insurance carrier to offer an integrated tool that functions to help ease a member's confusion while empowering the member to make better decisions as it relates to their own healthcare), etc.

As concerns debit card vendors, the subject system may be adapted to support a one debit card solution to the advantage of vendors by leveraging the system's integration and optimization techniques across FSA vendors, HSA banks and HRA vendors. Providers will have an incentive to work with debit card vendors as this optimization will not only be an invaluable differentiator as consumers are asked to be more responsible for their own healthcare spending decisions but will also function to reduce member confusion by automating the healthcare purchasing process.

As concerns hospitals and healthcare providers generally, the system will advantageously allow for an improvement in their revenue cycle as they may be provided with access to spending account balances and activities to allow for payment at the point of service.

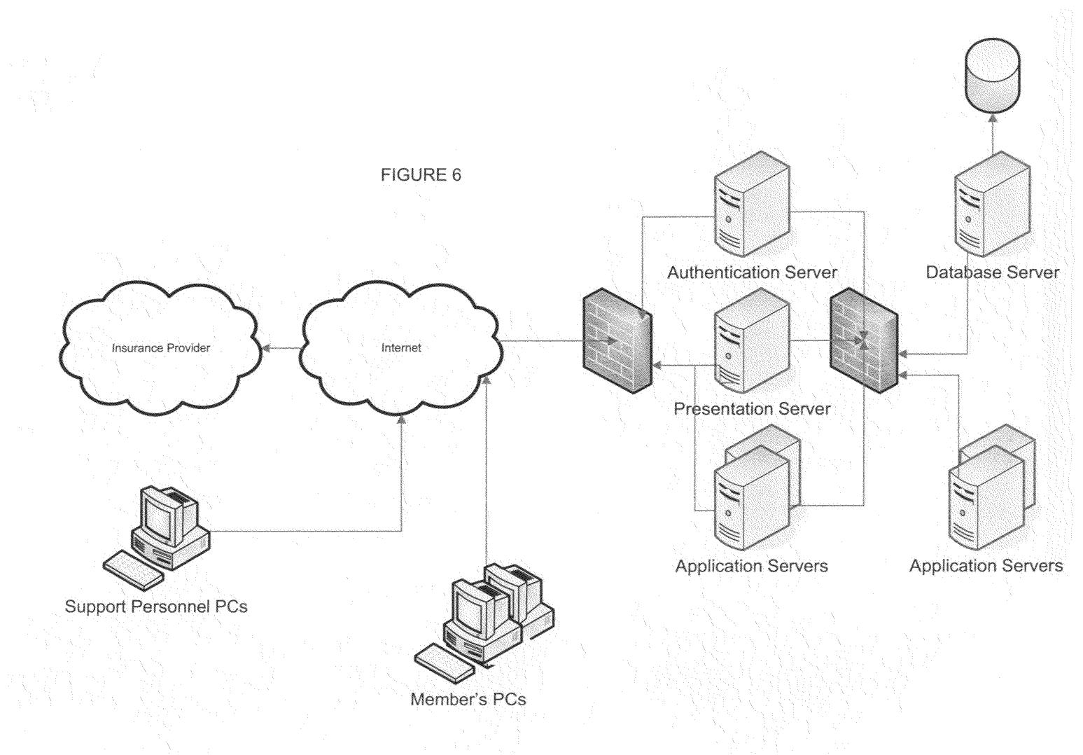

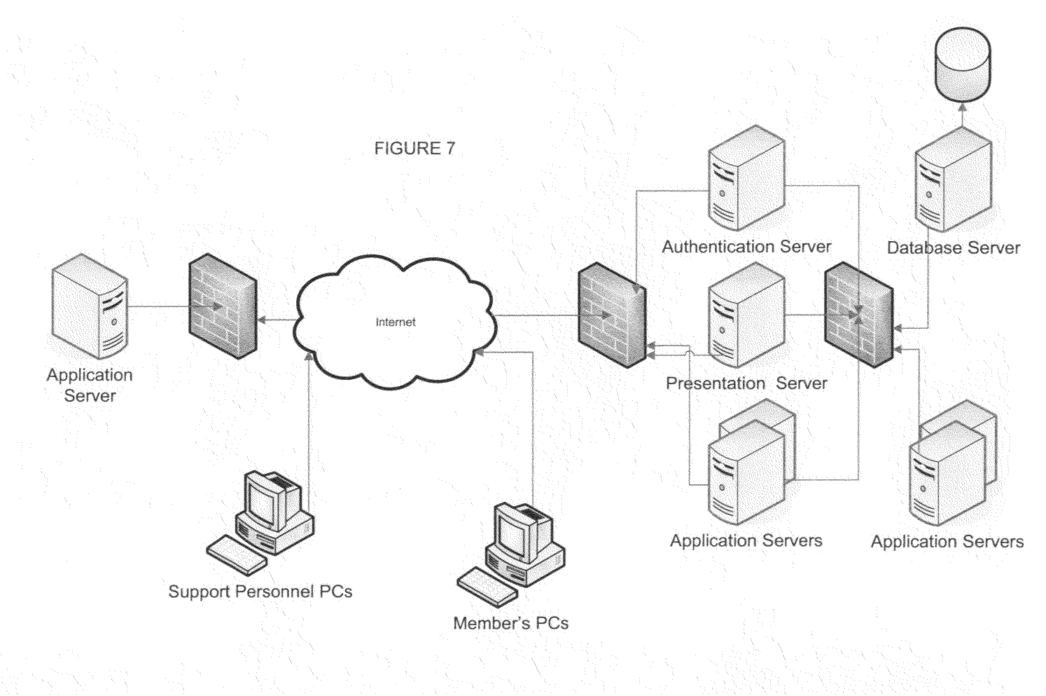

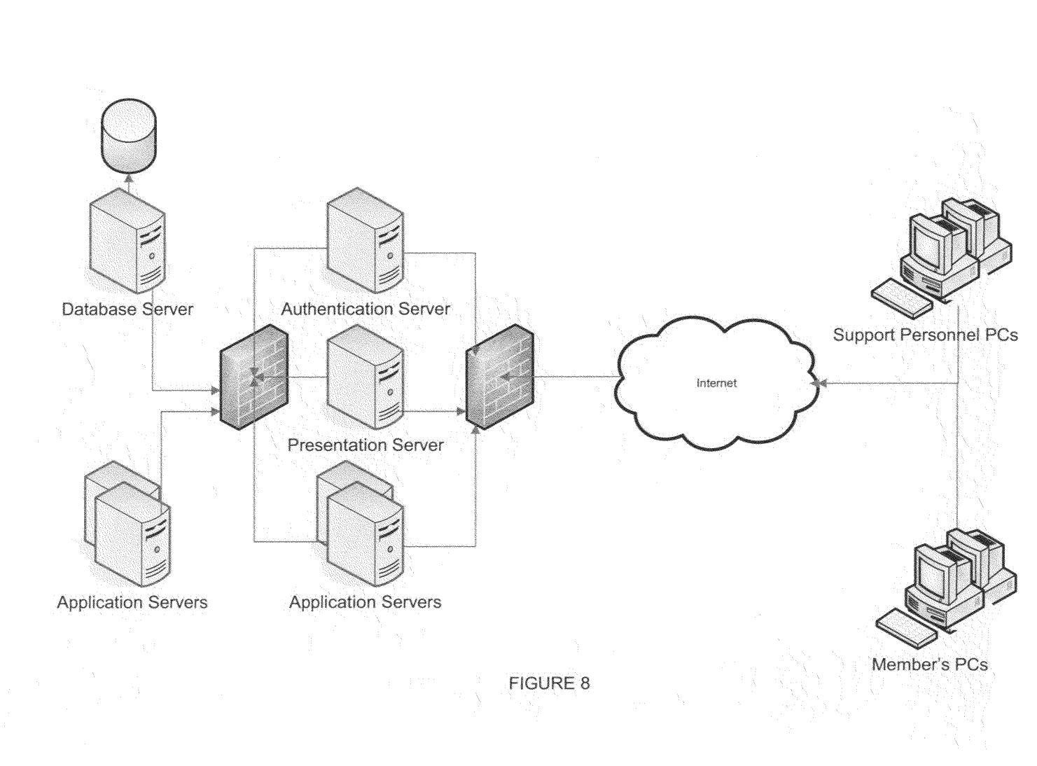

To provide the various benefits and to meet the objectives and goals set forth above, the subject system and method generally functions by collecting and integrating data from various sources and by processing this data for the purpose of generating information that will be useful in assisting a consumer with decisions that are to be made with respect to the use of their healthcare spending accounts. In this regard, the system and method may collect and integrate data from the consumer (e.g., personal and family information), insurance carriers and/or other eligibility and claim adjudications systems (e.g., an adjudicated claim amount), FSA vendors and third party administrators (“TPAs”) (e.g., account balance(s)), HRA vendors and TPAs (e.g., account balance(s)), HSA banks and TPAs (e.g., account balance(s)), pharmacy benefit managers (“PBMs”) (e.g., subscription costs), etc. Accordingly, to facilitate the collection of such data as well as to provide a means whereby consumers may gain access to the system, data, and information generated from the data by the subject system and method, the subject system and method may be embodied within the context of a various processing devices linked via a network, such as the World Wide Web or the Internet. For example, the systems and applications providing the services to be hereinafter described may be hosted by a third party that is separate from the insurance carrier of the using member as illustrated in FIG. 6, may be hosted by the insurance carrier of the using member as illustrated in FIG. 7, or may be partially hosted by a third party and partially hosted by the insurance carrier of the using member as illustrated in FIG. 8. Still further, the system may be adapted to electronically receive data and/or pull data, e.g., adjudicated claims, account balances, etc., from the appropriate sources. While the processing devices in the examples illustrated in FIGS. 6-8 are shown in the form of personal computers and servers which are provided with executable instructions to, for example, process data and provide consumer/system managers with the ability to interface with the system, etc., those skilled in the art will appreciate that the processing devices need not be limited to those processing devices shown but may be embodied in any device having the ability to execute instructions such as, by way of example only, a personal-digital assistant (“PDA”), cellular telephone, or the like. As will also be understood by those of ordinary skill in the art, the computer executable instructions will typically reside in program modules which may include routines, programs, objects, components, data structures, etc. that perform particular tasks or implement particular abstract data types.

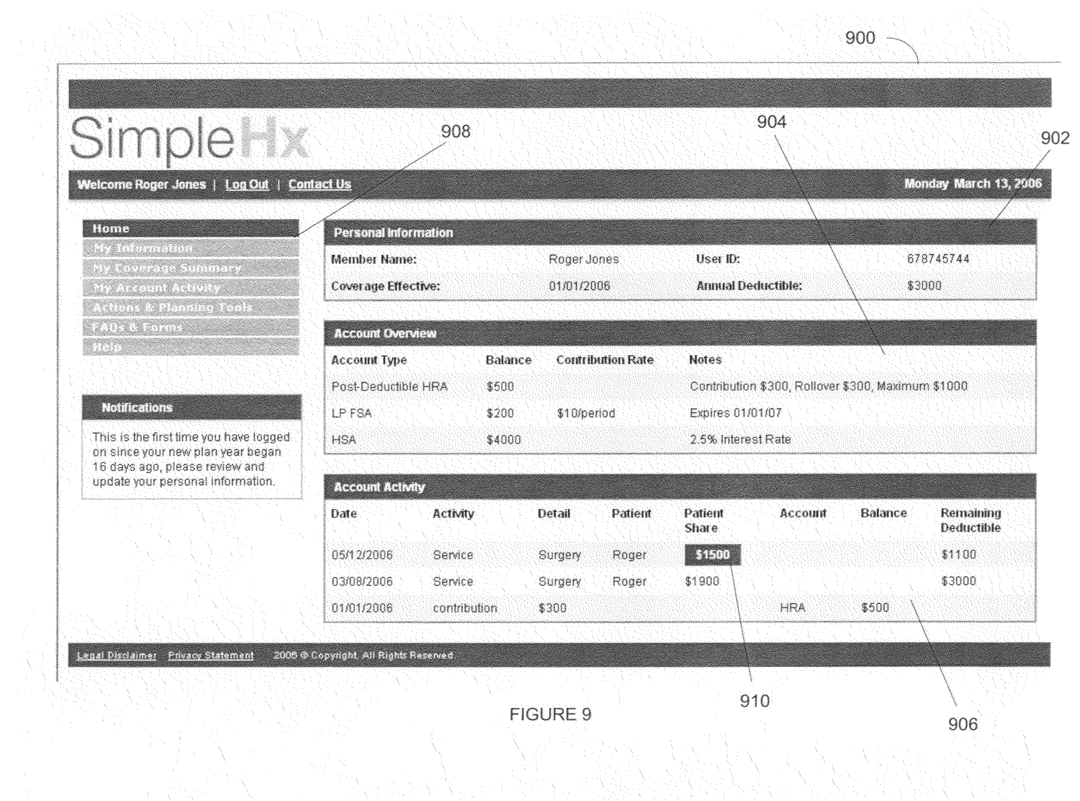

To provide secured access to the data as well as the information generated from the data, a using member may be required to access the system by first accessing the Web site of their insurance carrier as generally illustrated in FIGS. 6-8. In this regard, the using member may be required to provide a username and password pair which will be required to be authenticated by the insurance carrier before the user is allowed to further access the services offered by the system, whether the system services are hosted by a third party or by the insurance carrier. Once the using member has been authenticated by the insurance carrier of the using member, the using member may then be presented with a home page 900, an example of which is illustrated in FIG. 9. As generally illustrated, the home page 900 may display to the using member, without limitation, their relevant personal information 902, an overview of their healthcare accounts 904, and a brief summary of account activity 904 which displayed information would be retrieved from the system databases illustrated in FIGS. 6-8. From the home page 900, the using member will also be able to gain access to further informational pages described hereinafter using, for example, navigational tabs 908. From the home page 900 the using member may further gain access to a financial analysis tool, also described hereinafter, which functions to provide information to the using member for the purpose of providing guidance with respect to the use of their healthcare spending accounts as concerns the to-be-paid share of an adjudicated healthcare claim, i.e., the portion of an adjudicated healthcare claim which is not covered by the insurance carrier of the using member. In the example illustrated in FIG. 9, access to the financial analysis tool may be gained by the user simply clicking on a hyperlink 910 associated with a claim of interest.

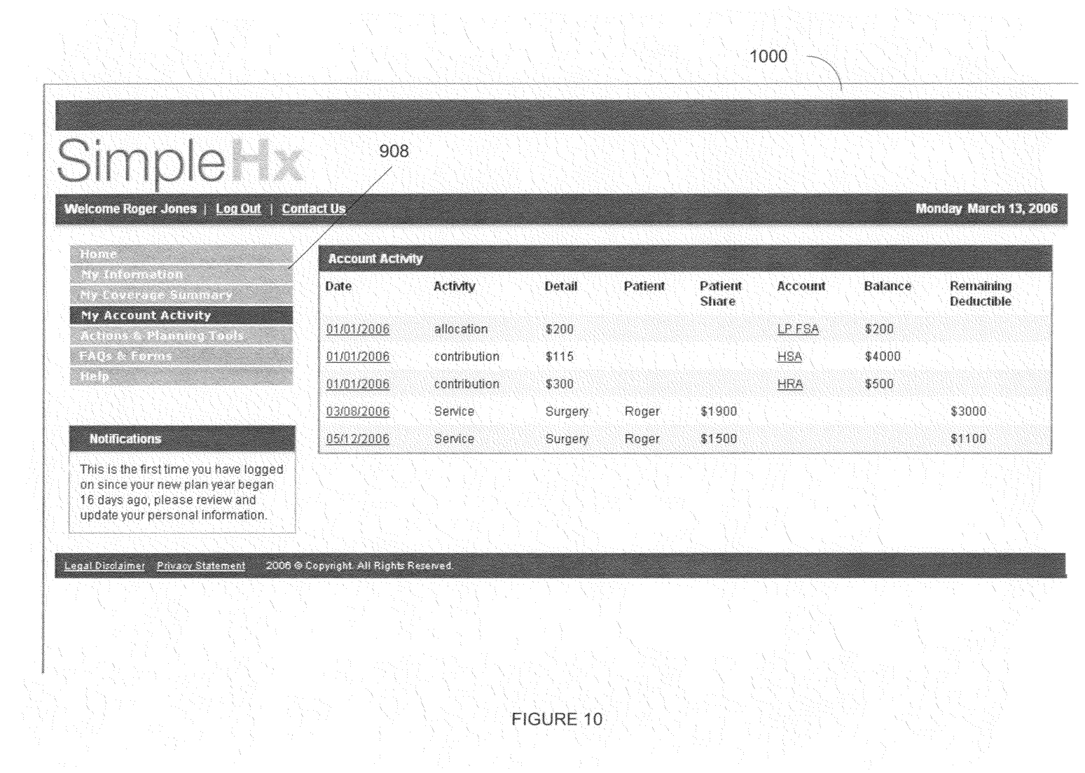

By way of further example, using the navigational tabs 908, the using member may gain access to their account information page 1000, an example of which is illustrated in FIG. 10. Generally, the account information page 1000 provides the user with a summary of events associated with their various healthcare accounts as well as a summary of events related to the receipt/purchase of healthcare goods and/or services. In certain circumstances, the fields associated with at least the summary of healthcare goods and/or services may be editable by the using member to thereby allow the using member to create a more definitive description of the healthcare goods and/or services received. In this regard, since the data that is to be provided to the system from healthcare providers (whether electronically or manually entered) may be generalized for reasons of personal privacy (e.g., the use of the term “surgery” as opposed to a more detailed description as to the type of surgery), the using member may find it desirous to supplement the data to thereby allow the using member to better discern in the future what was particularly received from the healthcare provider. As will be appreciated, such entered information may be returned to the databases with access to the information being limited in keeping with conditions of privacy. In a similar manner, the account activity information may also be supplemented by the using member to include “out-of-pocket” expenditures made by the using member for healthcare related services and/or goods which expenditures might not otherwise be capable of being tracked by the system. As will be appreciated, the information made available in the account activity page may be used to generate reports for use by the using member and/or may be made accessible to other applications that might advantageously use information as concerns healthcare expenditures, for example a tax planning application such a “TurboTax”

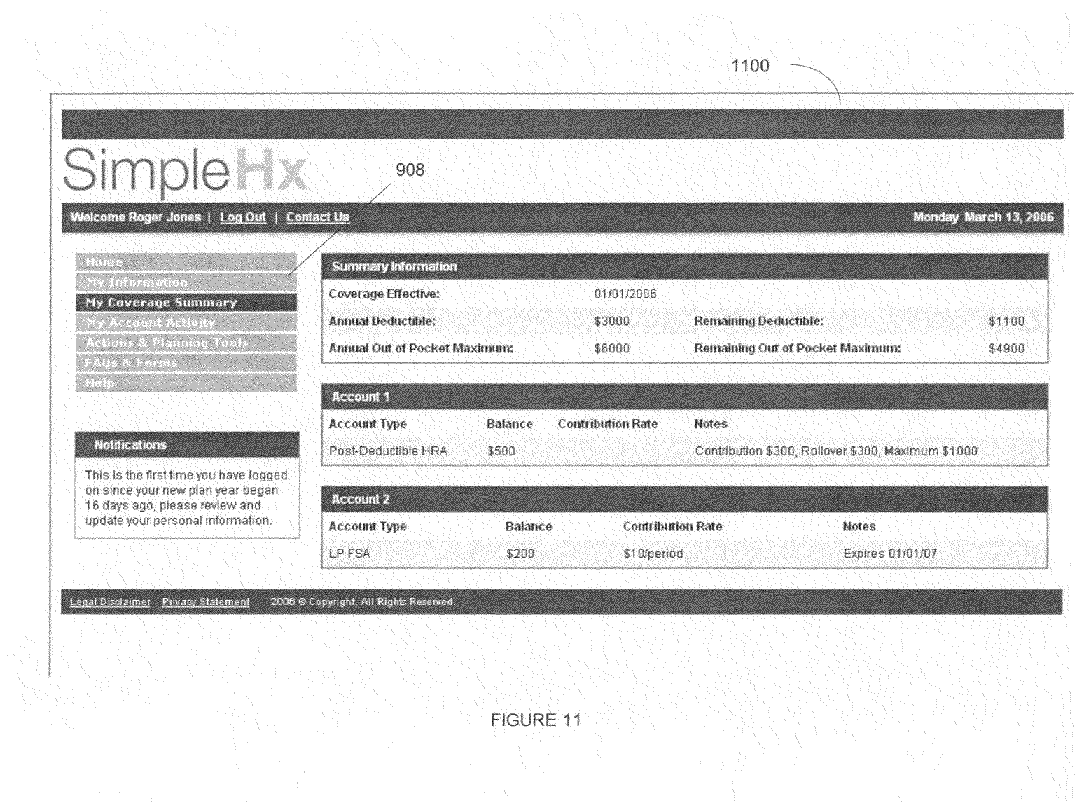

As further illustrated in FIG. 11, the navigational tabs 908 may be used to access a coverage summary page 1100 which generally displays to the using member the current status of the healthcare coverage provided by their insurance carrier as well as information concerning their various healthcare accounts.

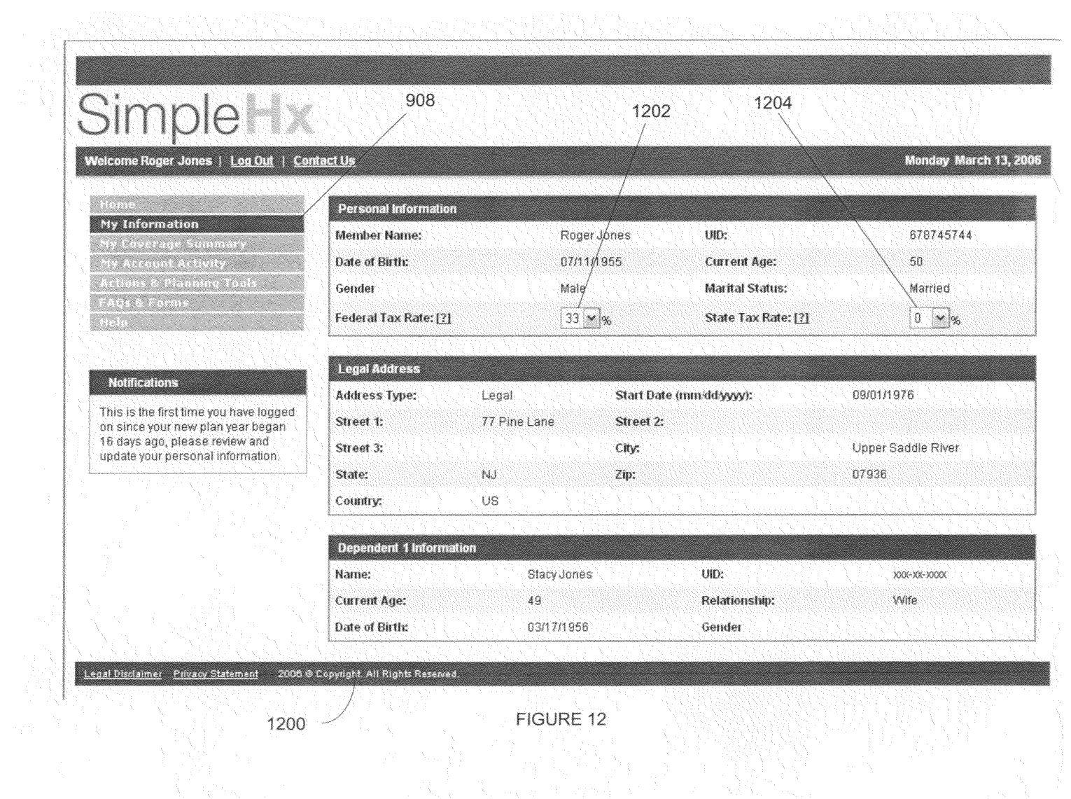

As still further illustrated in FIG. 12, the navigation tabs 908 may also be used to access a personal information page 1200 which generally displays to the using member and which allows the using member to edit, if necessary, their personal information. As will be appreciated, some of the personal information may be taken directly from information that the using member has already provided to their insurance carrier as part of the initiation of healthcare coverage which information would normally be stored in and be accessible from the databases of the insurance carrier, e.g., personal information of the using member such as their name, data of birth, marital status, age, gender, home address, dependent information (if any), etc. In addition, for reasons which will become apparent hereinafter, the personal information will also include various tax rates that are applicable to the using member, such as their (typically estimated) federal tax rate 1202 and their (typically estimated) state tax rate 1204. Still further, the personal information will also include a (typically estimated) rate of return for personal investment accounts and healthcare savings accounts owned by the using member.

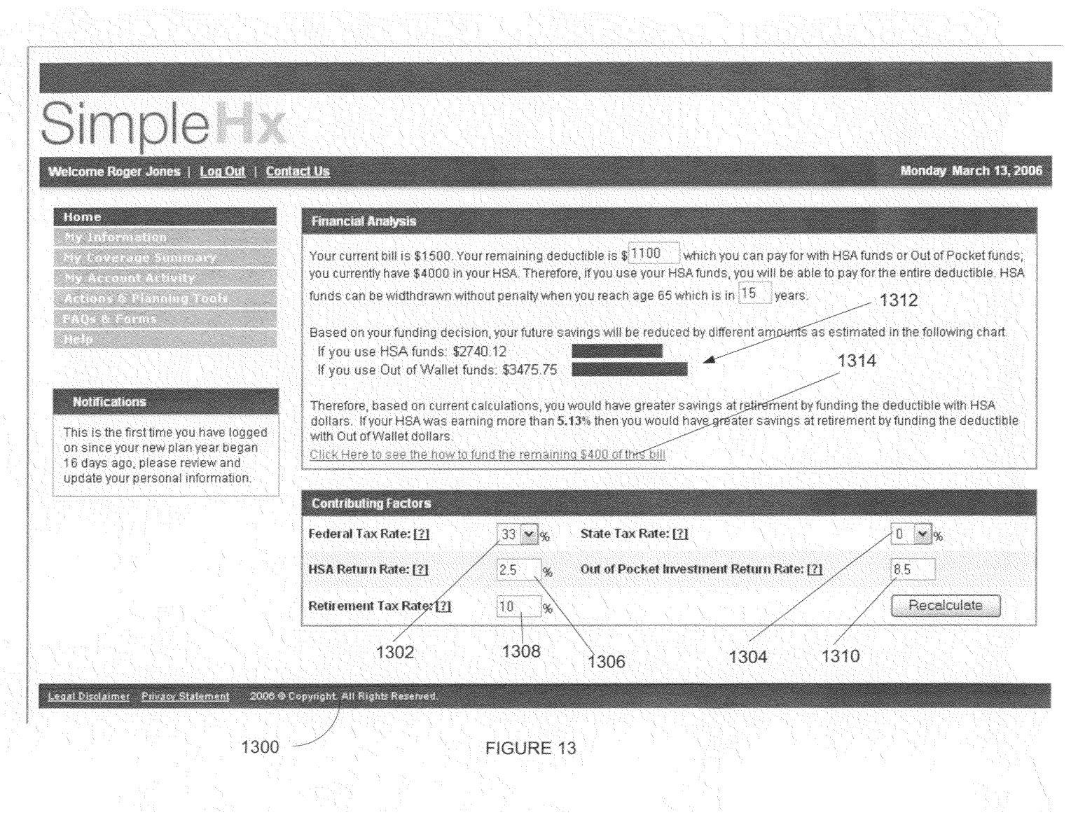

As discussed above, to assist a using member in planning how to best pay for their to-be-paid healthcare expenditures to thereby meet their current and future needs, the system provides a financial analysis tool 1300 as generally illustrated in FIG. 13. In this regard, the financial analysis tool generally functions to provide a using member with information that reflects determined outcomes that will result from the using member spending amounts within their various healthcare accounts, including out-of-pocket, when paying for their to-be-paid healthcare expenditures i.e., those portions of their healthcare costs that are not covered by their insurance carrier. In the example illustrated in FIG. 13 for instance, using the using member's provided federal tax rate 1302, state tax rate 1304, HSA return rate 1306, tax rate estimated for retirement 1308, and out-of-pocket investment return rate 1310 (e.g., the return rate of the user's investments such as mutual funds, savings accounts, etc.), the amount of the current healthcare bill, e.g., “$1500,” the limitations of the using members healthcare coverage, e.g., “$1100 remaining deductible,” and amounts currently available within the healthcare accounts of the user, e.g., “$4000 in your HSA,” and the healthcare savings fund distribution eligibility for the using member, e.g., “15 years,” to provide to the using member information 1312 as concerns the “costs,” e.g., impact on the using member's future personal savings, that are associated with paying for to-be-paid healthcare expenditure using funds within their various accounts, e.g., in this case to meet the remaining deductible. The system may also provide to the using member a link 1314 to further information that will function to explain to the user how to best cover any further expenses not covered under the using member's insurance coverage e.g., the “$400 dollars remaining” in this example. In this manner, the using member will be able to obtain guidance on decisions related to the use of spending account dollars and in some cases will see that, contrary to popular belief, it may be more desirable to pay for expenses using out-of-pocket dollars as opposed to dollars taken from HSA accounts. Furthermore, in the illustrated example, the various data points used in the calculations for generating account usage information may be made optionally editable to thereby allow the using member to see how changes to such data points may change the resulting account usage information that is provided.

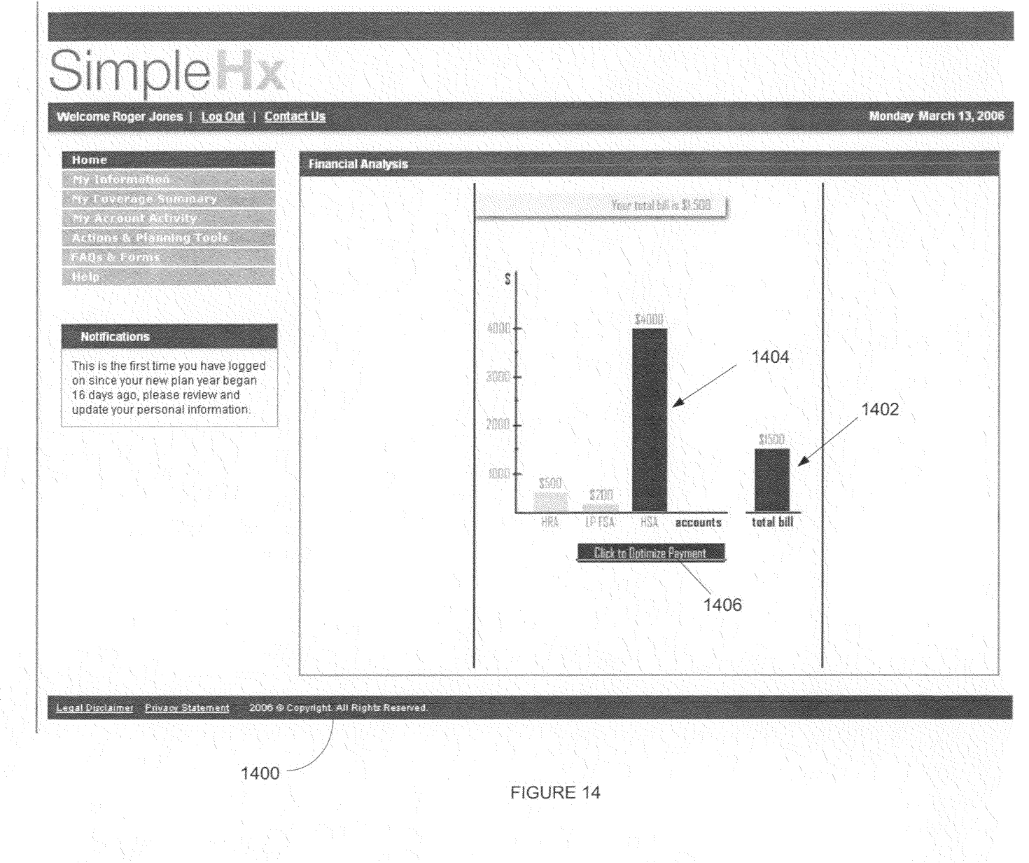

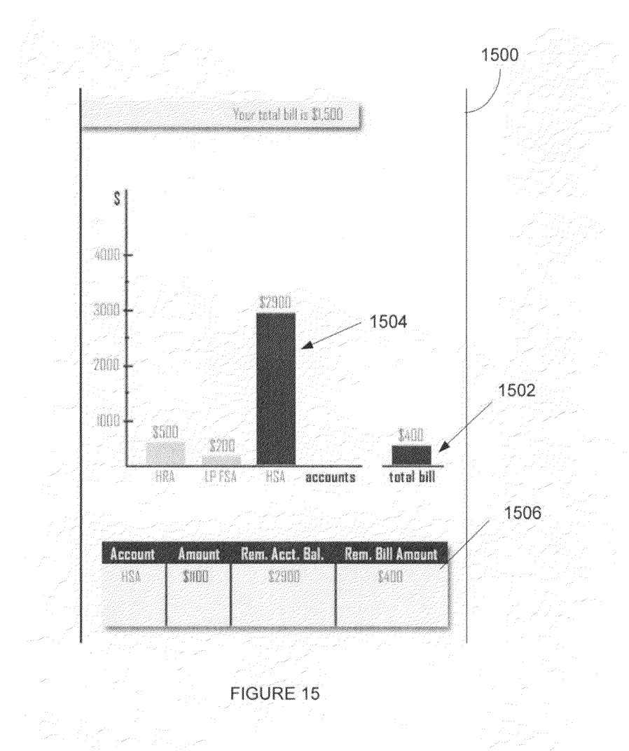

In keeping with the illustrated example, in response to the using member activating the link 1314, the using member may be provided with a series of informational frames (which may be presented to the user using a Web based media application) as generally illustrated in FIGS. 14-17. Specifically, the using member may be presented an informational page 1400, illustrated in FIG. 14, which depicts the total costs 1402 associated with the healthcare received as well as the funds available in the healthcare savings accounts of the using member 1404. In response to the using member requesting information with respect to how to optimize the payment of the total costs of the healthcare, for example by the using member activating link 1406, the system will present to the using member the informational frames depicted in FIGS. 15-17.

In FIG. 15, the informational frame 1500 presents to the user a portion of the healthcare costs which will remain outstanding 1502 if the using member uses a first considered healthcare account in a suggested manner. In the illustrated example, the portion of the total bill that will remain outstanding will be $400 if the using member pays the unmet insurance carrier's deductible using funds from their HSA account in keeping with the suggestion shown in FIG. 13. The informational frame 1500 additionally reflects the new balance of the funds within the HSA account 1504 that will result from the user performing payment in the manner suggested (e.g., $2900 which is the initial $40000 less the $1100 deductible to be paid from the HSA account) as well as a summary 1506 of the payment actions that have led to the balances depicted in informational frame 1500.

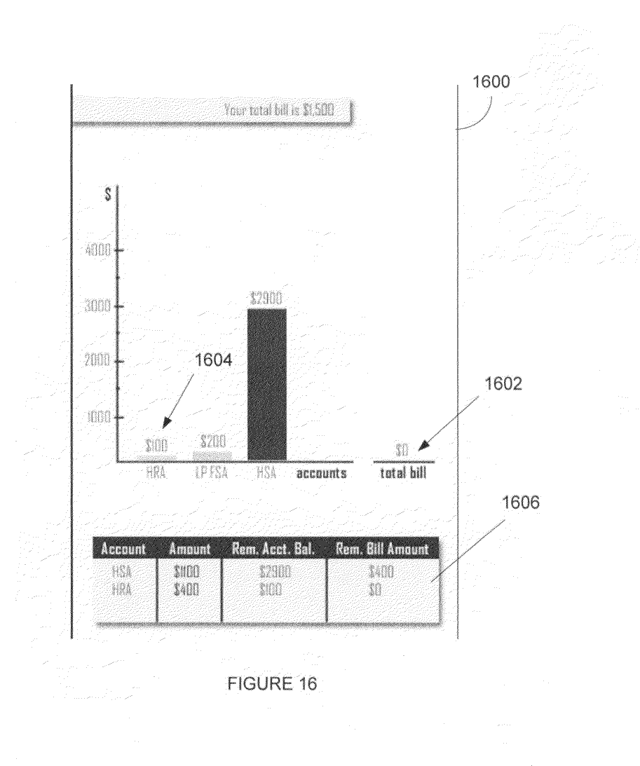

Continuing with FIG. 16, the informational frame 1600 again presents to the user a portion of the healthcare costs which will remain outstanding 1602 if the using member uses a next considered healthcare account in a suggested manner. In the illustrated example, the portion of the total bill that will remain outstanding will be $0 if the using member pays the remaining balance of the healthcare bill using funds from their HRA account which the system has determined as being the most optimal way to pay the remaining $400 balance. As before, the informational frame 1600 additionally reflects the new balance of the funds within the HRA account 1604 that will result from the user performing payment in the manner suggested (e.g., $100 which is the initial $500 less the $400 balance to be paid from the HRA account) as well as a summary 1606 of the payment actions that have led to the balances depicted in informational frame 1600.

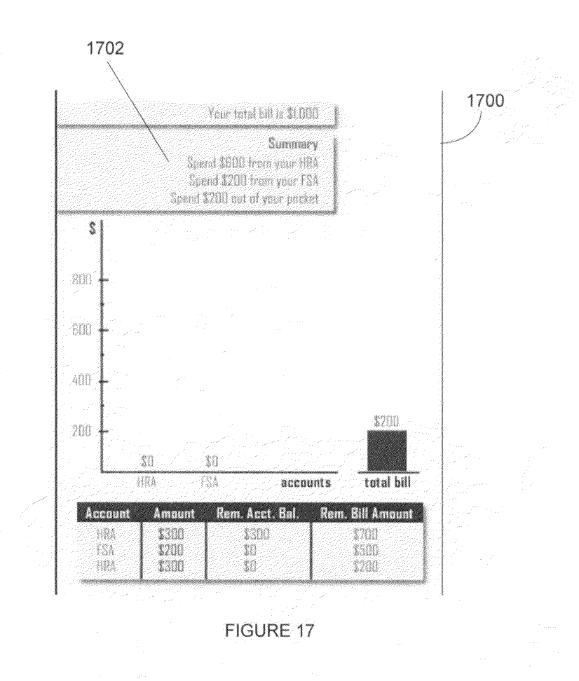

While the illustrated example need not consider further payment options from further healthcare accounts (or the “out-of-pocket” account of the using member) since the remaining balance to be paid by the using member will be reduced to zero if the using member pays for the healthcare costs in the manner suggested, it will be appreciated that the informational frames may continued to be displayed in the manner illustrated in the event that consideration of further spending accounts is required to meet the payment obligations of the using member. For example, FIG. 17 illustrates an informational page 1700 in which it is suggested that the using member pay a remaining balance, e.g., $200 which is remaining after payment of suggested amounts of $300 from the HRA account of the using member, $200 from the FSA account of the using member, and another $300 from the HRA account of the using member, from a personal account of the using member, i.e., “out-of-pocket.” As further illustrated in FIG. 17, upon the conclusion of the presentation of the informational frames in which suggested payment options are presented to the using member, a summary 1702 of those suggestions are also provided to the using member.

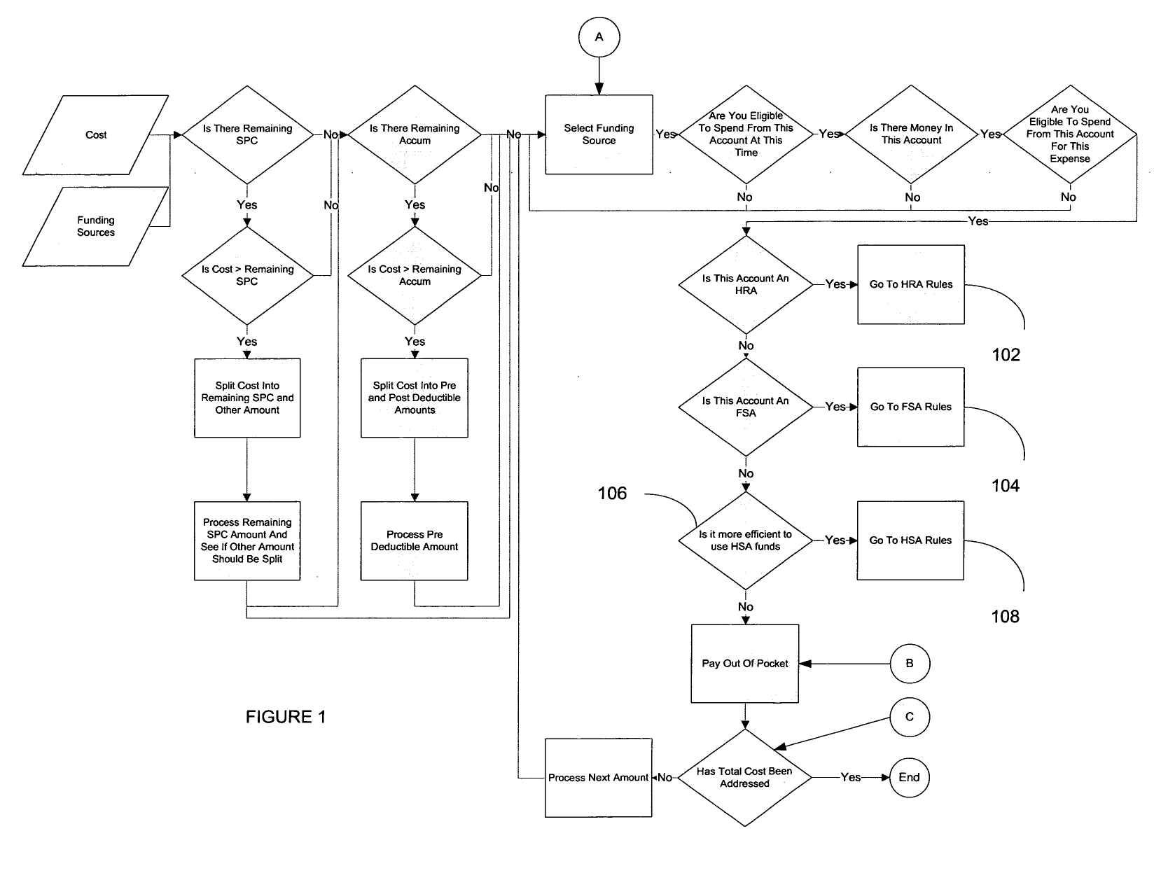

To formulate the payment suggestions that are presentable to the using member, which may be presented in the manner set forth above or using any other appropriate means of communication without limitation, the system, as generally illustrated in FIG. 1, considers the healthcare costs and the amounts in the one or more healthcare accounts of the using member as well as various rules that are applicable to the various healthcare accounts. The processing by the system may be performed for each line item in a using member's healthcare bill as some items may be subjected to different rules, e.g., some items may be subject to a deductible while others may not, some items may be eligible to be funded from certain accounts while others may not, etc. Upon conclusion of the processing, as evidenced above, the system will aggregate all the expenses and report to the using member the optimal debits to each account and, in the case of multiple items on a healthcare bill which may be subject to different deductibles, the decision of whether to recommend payment using a HSA account and/or an “out-of-pocket” account can be deferred until all costs in the relevant category are defined to thereby allow only one determination as concerns that payment option. It is to be additionally understood that, while FIG. 1 illustrates consideration of the amounts in a HRA account, a FSA account, and a HSA account (provided the using member has such accounts), in the future additional healthcare accounts may be created and accordingly considered. Generally, such accounts, if to be considered in the future by the system, would be considered in an order that is consistent with the order in which the accounts illustrated within FIG. 1 are considered, namely, from most restrictive in usage to least restrictive in usage.

More particularly, once a request to review a healthcare bill is received into the system, the system may first determine whether the using member has a remaining self pay corridor (“SPC”), e.g., the amount the using member must pay before the using member may access the funds in the HRA (if any), and/or if the using member has any remaining deductibles to meet given the cost amounts set forth within the healthcare bill. If the using member has a remaining SPC and/or a remaining deductible to meet, the system will proceed to consider these costs and how these costs, as well as the remaining healthcare costs, are to be paid using the healthcare spending accounts of the using member. If the using member has no further SPC or deductibles to meet, the system will still proceed to consider how the remaining healthcare costs are to be paid using the healthcare spending accounts of the using member. In either instance the system will then select one of the funding sources (e.g., one of the types of healthcare accounts of the using member which types of healthcare accounts are considered in an order using the preference discussed above and, which as illustrated in FIG. 17, may be reconsidered as a part of the overall processing performed by the system (noting that the HRA account was considered twice)) and proceed to determine if the using member is eligible to spend from the selected type of healthcare account at this time, if the type of healthcare account has funds, and if the type of healthcare account can be used to cover the specific costs of the item of the healthcare bill currently being considered by the system.

As further illustrated in FIG. 1, in the event that the type of healthcare account presently being considered is a HRA account, the system will apply rules associated with HRA accounts 102 to determine what amount, if any, of the healthcare bill the system should suggest as being paid for from a HRA account. In the event that the type of healthcare account presently being considered is a FSA account, the system will apply rules associated with FSA accounts 104 to determine what amount, if any, of the healthcare bill the system should suggest as being paid for from a FSA account. In the event that the type of healthcare account presently being considered is a HSA account, the system will apply rules associated with HSA accounts 108 to determine what amount, if any, of the healthcare bill the system should suggest as being paid for from a HSA account.

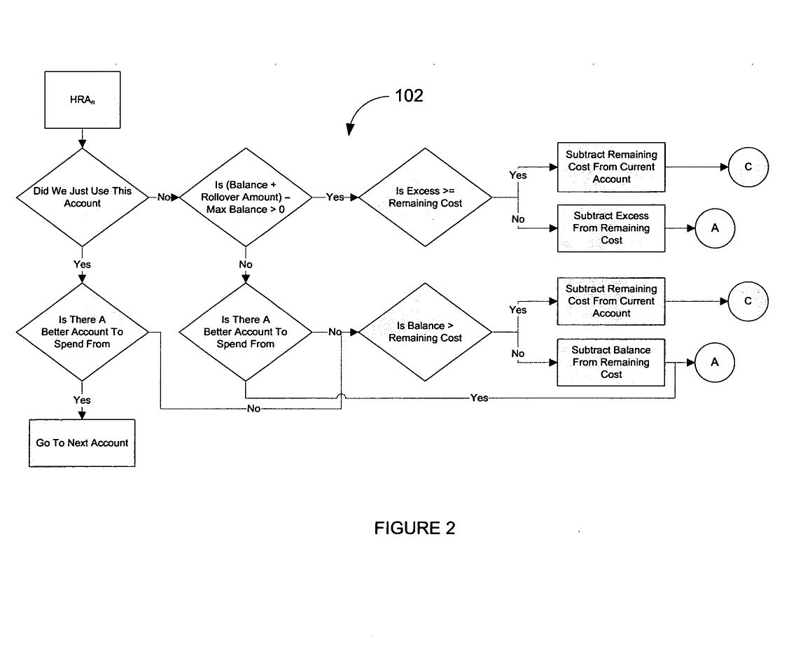

Turning to FIG. 2, to determine if the system should suggest payment from a HRA account of the using member, the system first determines if the HRA account presently being considered was immediately previously considered by the system. This checking is preferred since, as noted above and illustrated in the figures, the system can reconsider usage of these healthcare accounts as a funding source to account for a possibility that a restriction, e.g., a deductible, which may limit the initial or amount of use a healthcare account is met when the system determines payment suggestions using other healthcare accounts. If the system determines that the account was immediately, previously considered, the system may then determine if there exists a “better” account to spend from (e.g., considering the relative limitations and ramifications of usage of the accounts) and, if a better account to spend from is found, the system will go forward and consider the other accounts as a source of payment and, if no better account is found, the system will continue by evaluating whether the HRA account may still be used to meet the cost presently being considered as illustrated in FIG. 2.

If the HRA account was not just previously used in the evaluation process and is therefore desired to be further considered, the system continues by determining if the HRA account has an excess of funds and, if so, the system preferably suggests payment using the excess funds from this account if the excess funds are “use it or lose it” funds. In the event that the excess funds in the HRA account are not sufficient to cover the healthcare costs to-be-paid by the using member, the system suggests that the using member pay for the healthcare cost using the excess funds and continues on to determine which other accounts (and amounts from those accounts) should be suggested for use by the using member in meeting the using member's remaining balance of the to-be-paid healthcare costs. In the event that the system determines that no excess funds exist in the HRA account being considered, the system may continue processing by investigating other eligible accounts, e.g., HRA accounts (if any) or FSA accounts (if any), to determine if they might be better suited for the cost being considered. In the event that the system determines that no better accounts exist, the system may continue by determining if the funds in the HRA account being considered are nevertheless sufficient to cover all or part of the cost and, if so, it will suggest that these funds be used to cover all of the using members to-be-paid cost, if possible, or suggest that this spending account be paid to zero with the then remaining balance being further considered by the system.

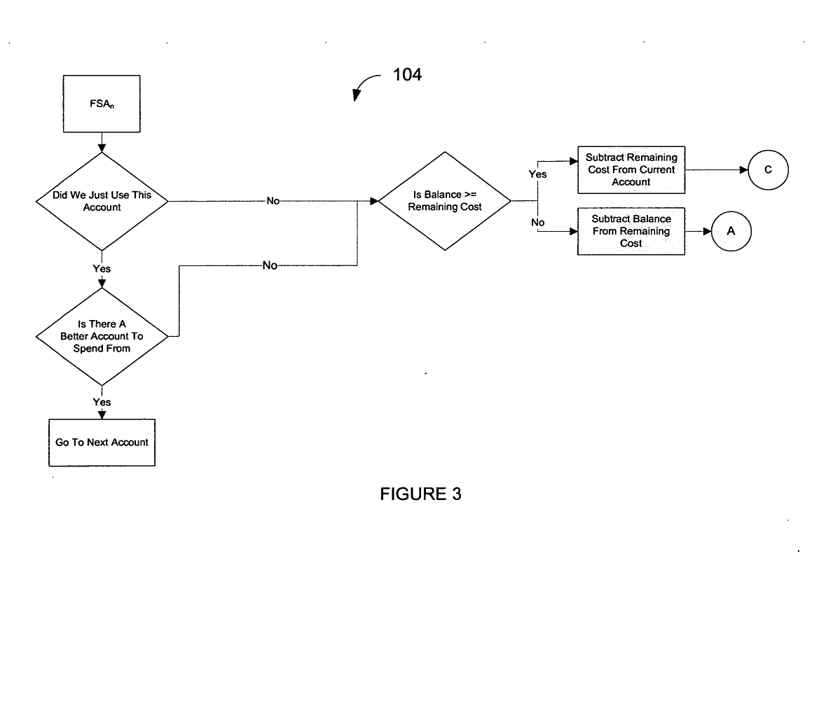

If the account being considered by the system is a FSA account, the system, as generally illustrated in FIG. 3, may again first determines if the FSA account presently being considered was immediately previously considered by the system. If the FSA account was immediately previously considered by the system, the system will go forward and consider whether another healthcare account might be better used to meet the cost currently being considered. In the event that the FSA account is to be further considered by the system, the system continues by determining if the balance within the FSA account is sufficient to cover the to-be-paid cost of the healthcare bill and, if so, the system will suggest that the to-be-paid cost of the healthcare bill be funded from this FSA account. In the event that the FSA account has funds, but in an amount insufficient to cover all of the to-be-paid cost of the healthcare bill being considered, the system will suggest that this FSA account be spent to zero and proceed to consider other healthcare spending accounts of the using member, if any.

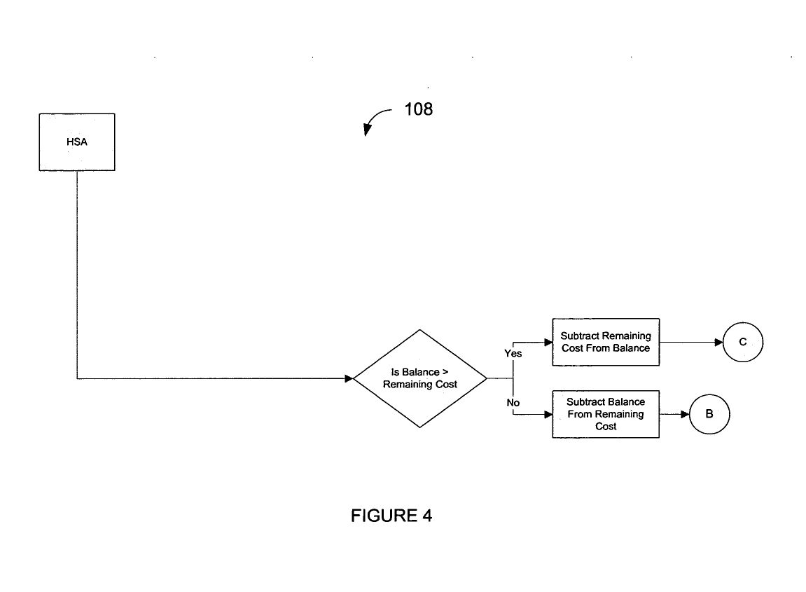

If the using member is unable to pay all of the to-be-paid costs associated with the healthcare bill using funds from the HRA and/or FSA accounts of the user, the system will determine 106 the efficiencies associated with the using member paying any remaining balance of the healthcare bill cost using funds from a HSA account and/or using “out-of-pocket” funds. When considering the use of HSA funds, the system will, as illustrated in FIG. 4, determines if the HSA account has funds in an amount sufficient to cover the to-be-paid cost and, if so, functions to inform the user that, if the HSA account is to be used to pay for the to-be-paid cost what the economic impact on the using member will be (see FIG. 13). If the HSA account fails to have funds in an amount sufficient to cover the to-be-paid cost, the system will spend the HSA account to zero and may again inform the using member as to what the economic impact will be with it being appreciated that the then remaining balance will have to covered using the “out-of-pocket” funds of the using member.

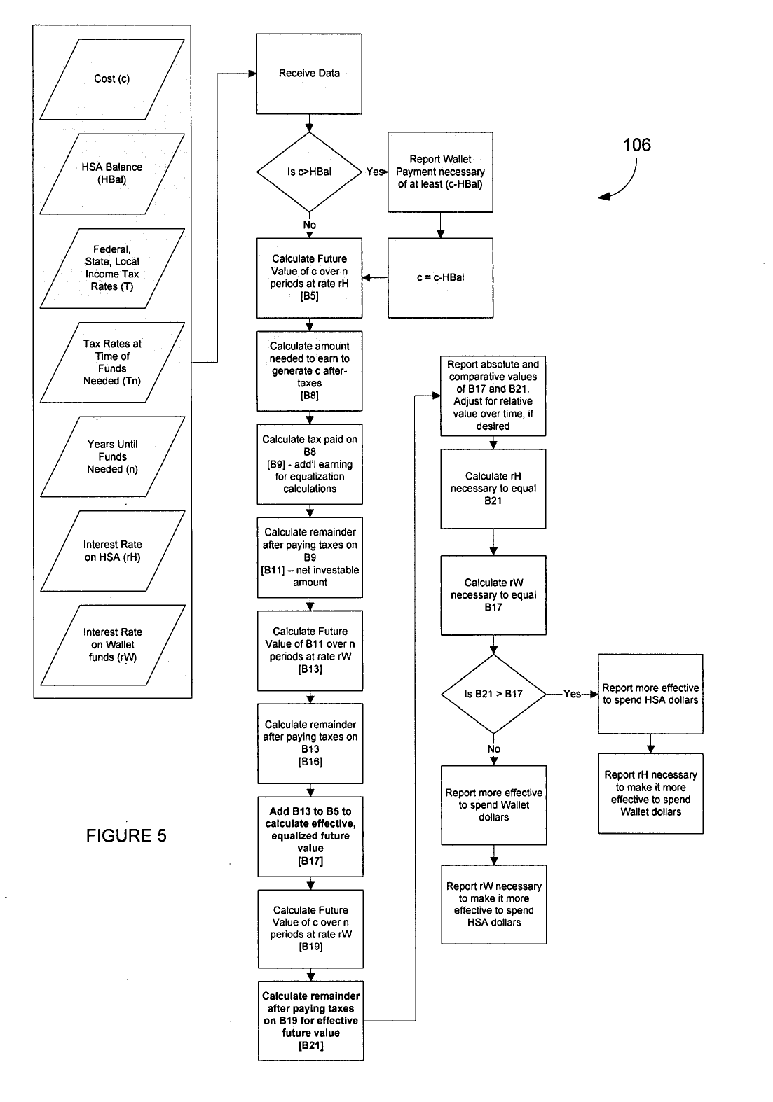

As noted, the system preferably evaluates the efficiencies, i.e., the overall economic impact, of the using member using funds from their HSA account to pay costs associated with their healthcare bill relative to the using member using “out-of-pocket” funds to pay costs associated with their healthcare bill. While it is preferred that the system will present to the using member information whereby the user may see the impact associated with paying using HSA funds versus “out-of-pocket” funds, as illustrated in FIG. 13, it will be appreciated that the system may merely present to the users suggested payment options without providing to the user such information, e.g., the system may merely provide the suggested amount (if any) to pay from an HSA account and the suggested amount (if any) to pay from an “out-of-pocket” account. In either case, i.e., whether to display the information to the user or to make the ultimate decision for the user, to evaluate the impact of payments made using funds from a HSA account versus the use of funds from an “out-of-pocket” account, the system, as illustrated in FIG. 5, will use the various tax rates and interest rates of the using member, discussed above, to perform an equalization of the HSA dollars that might be suggested for use in meeting the obligations of payment to “out-of-pocket” dollars.

More particularly, the equalization happens by generally subtracting the payment amount from the required earnings, taxing the difference, and then investing the remaining amount at the specified interest rate for the “out-of-pocket” account(s) over a specified time frame. The system then adds the determined amount to the future value of the HSA dollars to arrive at the equalized, effective future value of the HSA [B17]. The system then continues by calculating the effective future value of the required earnings and subtracting taxes to thereby yield the effective future value of the “out-of-pocket” funds [B21]. Then, as noted, this determined information may be reported to the member as illustrated in FIG. 13, adjusting for relative value over time (such as inflation), if necessary and appropriate. As further illustrated in FIG. 13, the system may also calculate the rates necessary on the HSA and/or “out-of-pocket” investments to create parity which information is presentable to the using member, e.g., “if your HSA was earning more than 5.13%, then you would have greater savings . . . ” As will be appreciated, this information allows the using member to better understand how investment choices would change funding recommendations since the system determines for the using member which future value is lower and shows to the using member that it would be more effective to spend money from a particular source because spending from that source (if the using member is capable of doing so) would be reducing future earnings by a relatively lesser amount. Still further and as discussed previously, the system may optionally provide for the using member to change all or some of the variables to model different payment scenarios for themselves. In this regard, the using member may be presented within the opportunity to reduce the amount of the bill (for modeling purposes which may, for example, demonstrate overall cost of a generic versus a brand name drug when purchased by a using member). By way of example, if a bill is $1000 and the using member has $1000 of HSA funds but only $500 of “out-of-pocket” funds available, the using member could change the amount of the bill to $500 to see if the system recommends that the using member should spend $500 HSA and $500 from their own wallet or $1000 HSA.

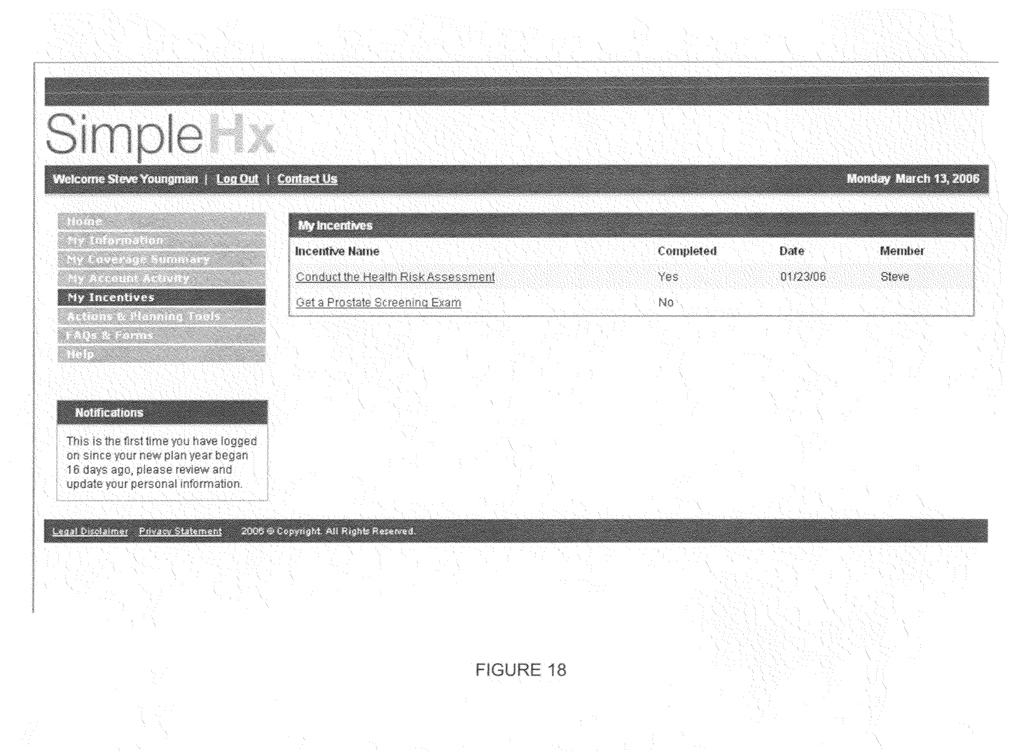

As a further benefit to using members, the system may also present information that informs a using member of the value associated with the using member performing activities to which an incentive has been attached, as illustrated in FIG. 18. In this regard, the system may not only function to monitor compliance with the incentives but may also provide to the using member the future dollar value that may be realized if the using member actually fulfills the task associated with the incentive. For example, if fulfillment of the incentive results in an employer providing $50 to the HRA account of the using member, it will be appreciated that the amount may have a future impact on the amount of money the using member may save by not having to spend an equivalent amount from their HSA or “out-of-pocket” funds, which amount may be presented to the user to motivate the user to, in fact, perform the incentive tied healthcare task.

Yet further, it will be appreciated that, as a convenience to using members, the system may not only suggest how the using member should pay for healthcare, but may be linked to the various accounts of a using member such that, if the using member accepts the suggestions received from the system (or otherwise modifies the payment options in an acceptable manner), the using member can instruct the system to debit the accounts of the using member accordingly for the purpose of clearing the healthcare bill. Similarly, a single debit card can be linked to the various accounts of the using member to allow for ease of payment and tracking of payment.

All of the patents and/or patent applications disclosed within this document are hereby incorporated by reference in their entirety.

While various concepts have been described in detail, it will be appreciated by those skilled in the art that various modifications and alternatives to those concepts could be developed in light of the overall teachings of the disclosure. For example, it will be appreciated that the subject invention may be easily adapted to handle not only all variations of existing healthcare spending accounts (e.g., post deductible HRAs or FSAa or Limited Purpose FSAs) but will also be easily adapted to handle any yet-to-be-introduced healthcare accounts. Similarly, it will be appreciated that software may be easily added to the system to allow insurance carriers to use the data collected and/or information generated to print reports for their members to thereby provide a yet-to-be-seen level of integration. Yet further, it will be appreciated that the system will be able to compile data on consumer spending habits to thereby help insurance carriers and/or employers better define plans and/or guidelines as well as decrease unnecessary utilization while still meeting the objective of assisting consumers in the optimal use of their healthcare dollars. Accordingly, it will be further appreciated by those skilled in the art that the particular concepts disclosed are meant to be illustrative only and not limiting as to the scope of the invention which is to be given the full breadth of the appended claims and any equivalents thereof.

What is claimed is:

1. A system for providing information with respect to healthcare spending accounts, comprising:
a database in which is stored information concerning amounts in one or more healthcare spending accounts of a consumer, information concerning a healthcare plan under which the consumer is covered, information concerning relevant tax rates for the consumer, information concerning a rate of return on investment for a out-of-pocket fund of the consumer, and information concerning a rate of return on investment for a healthcare spending account of the consumer; and
programming which functions to use the information stored in the database to evaluate and inform the consumer how the consumer should spend the amounts in their healthcare spending accounts to meet costs associated with a healthcare bill that are to be paid for by the consumer.

2. The system as recited in claim 1, wherein the healthcare accounts comprise one or more of a HRA, a FSA, and a HSA.

3. The system as recited in claim 1, wherein the relevant tax rates comprise one or more of a federal tax rate and a state tax rate.

4. The system as recited in claim 1, wherein the information provided to the consumer as to how the consumer should spend the amounts in their healthcare spending accounts to meet costs associated with the healthcare bill that are to be paid for by the consumer is presented on a Web page.

5. The system as recited in claim 4, wherein the Web page and the programming cooperate to allow the consumer to at least temporarily modify at least a part of the information stored in the database to thereby allow the programming to use the modified information to evaluate and inform the consumer how the consumer should spend the amounts in their healthcare spending accounts to meet costs associated with the healthcare bill that are to be paid for by the consumer.

6. The system as recited in claim 4, wherein the Web page and the programming cooperate to allow the consumer to at least temporarily modify the costs associated with the healthcare bill that are to be paid for by the consumer to thereby allow the programming to use the information stored in the database to evaluate and inform the consumer how the consumer should spend the amounts in their healthcare spending accounts to meet costs associated with the modified healthcare bill that are to be paid for by the consumer.

7. The system as recited in claim 1, wherein the system is adapted to retrieve at least a portion of the information stored within the database from a computer system associated with a financial institution.

8. The system as recited in claim 1, wherein the system is adapted to allow the consumer to pay for all or part of the costs associated with the healthcare bill by issuing an instruction to a financial institution to debit a healthcare account maintained by the financial institution.

9. The system as recited in claim 1, wherein the information provided to the consumer as to how the consumer should spend the amounts in their healthcare spending accounts to meet costs associated with the healthcare bill that are to be paid for by the consumer comprises an estimation as to the future impact of paying for the costs using out-of-pocket funds versus paying for the costs using funds in an interest earning healthcare account.

10. The system as recited in claim 1, wherein the programming is adapted to present to the consumer a summary of activities related to one or more of the healthcare accounts.

11. The system as recited in claim 1, wherein the programming is adapted to present to the consumer a summary of healthcare services associated with healthcare bills that have been made known to the system.

12. The system as recited in claim 11, wherein the programming is adapted to allow the consumer to edit a description of the healthcare services set forth in the summary.
